(19) United States
(12) Patent Application Publication
(10) Pub. No.: US 2007/0193608 A1
(43) Pub. Date: Aug. 23, 2007

(54) Sink mounting type dish washer

(76) Inventor: Byoung Woo Kim, Kwangmyung-si (KR)

Correspondence Address: IPLA P.A., 3580 WILSHIRE BLVD., 17TH FLOOR, LOS ANGELES, CA, 90010, US

(21) Appl. No.: 10/599,108

(22) PCT Filed: Mar. 9, 2005
(86) PCT No.: PCT/KR05/00657

§ 371 Date: Sep. 19, 2006

(30) Foreign Application Priority Data
Mar. 19, 2004 (KR) 10-2004-0018846

(51) Int. Cl. B08B 3/00

(52) U.S. Cl. 134/56 D; 134/58 D

(57) ABSTRACT

The invention relates to a sink mounting type dish washer, and more particularly, relates to a sink mounting type dish washer which may be conveniently attachable to a conventional sink. According to an aspect of the invention, there is provided a sink mounting type dish washer comprising a drain body 15 mounted at the bottom of a water container 10, a cap 20 which is provided at the upper portion of the drain body 12 and opens and closes the drain body 12, an outer body 30 which is detachably combined at the periphery of the drain body 12 and in which a first coil 25 is embedded, a core 40 which is sealingly embedded in the cap 20 and to the periphery of which a second coil 35 is winded, an ultrasonic vibrator 45 which is provided at the upper portion of the cap 20 and is connected to the second coil 35 in the cap 20 and is operated by the induction current generated at the second coil 35, and a controller 60 which is connected to the first coil 25 and supplies electric power to the first coil 25 by the signal inputted from a separate control panel 50.

### TECHNICAL FIELD

The invention relates to a sink mounting type dish washer, and more particularly, relates to a sink mounting type dish washer which may be conveniently attachable to a conventional sink.

### BACKGROUND OF THE INVENTION

A dish washer has been disclosed recently that includes a water container and an ultrasonic vibrator mounted at the bottom of the water container. According to this dish washer utilizing the ultrasonic vibrator, table dishes may be washed by the water vibrated by the ultrasonic vibrator. This washer has the advantage that washing efficiency may be enhanced more than the conventional water jet type dish washer. However, this washer requires special installing space and it brings about in-convenience in use.

In order to solve this problem, a sink incorporated with a dish washer has been disclosed recently. This sink includes an ultrasonic vibrator attached at the bottom of a sink and a water pipe attached at one side of the sink. This sink is mainly applied for a new house because it has the advantage that it dose not require special space for installing a dish washer.

However, in order to apply this sink for the house which has a conventional sink, the conventional sink should be removed and replaced with a new sink. Accordingly, the sink incorporated with a dish washer may increase the cost because a consumer should buy a new sink and should replace the conventional sink. And, the above sink brings about unnecessary waste of resource because the conventional sink which is still usable should be removed.

### DETAILED DESCRIPTION OF THE INVENTION

The invention is created to solve the above described problems and so the object of the invention is to provide a sink mounting type dish washer which may be easily attachable to a conventional sink and may save the cost because a consumer need not buy a new dish washer or need not remove the conventional sink and which may make the kitchen more spacious.

According to an aspect of the invention, there is provided a sink mounting type dish washer comprising:

a drain body 15 mounted at the bottom of a water container 10;

a cap 20 which is provided at the upper portion of the drain body 12 and opens and closes the drain body 12;

an outer body 30 which is detachably combined at the periphery of the drain body 12 and in which a first coil 25 is embedded;

a core 40 which is sealingly embedded in the cap 20 and to the periphery of which a second coil 35 is winded;

an ultrasonic vibrator 45 which is provided at the upper portion of the cap 20 and is connected to the second coil 35 in the cap 20 and is operated by the induction current generated at the second coil 35;

and a controller 60 which is connected to the first coil 25 and supplies electric power to the first coil 25 by the signal inputted from a separate control panel 50;

and wherein washing function may be provided to the conventional sink because the outer body 30 having the first coil 25 may be inserted into the drain body 15 and the conventional cap may be replaced with the cap 20 having the core 40 to the periphery of which the second coil 35 is winded.

According to another aspect of the invention, there is provided a sink mounting type dish washer further comprising:

RF modules 65, 70 which are respectively provided on the controller 60 and the control panel 20;

and wherein the control panel 20 may be arbitrarily located because a signal may be wirelessly transmitted from the control panel 20 to the controller 60.

### BRIEF DESCRIPTION OF THE DRAWINGS

FIG. 1 is the cross-sectional view of a preferred embodiment of the invention.

FIG. 2 is a dissembled perspective view of a outer body and a drain body of FIG. 1.

FIG. 3 is a block diagram of the invention.

FIG. 4 is the block diagram of another embodiment of the invention.

FIG. 5 is the perspective view showing the embodiment that the control panel of FIG. 4 is mounted.

### THE PREFERRED EMBODIMENT OF THE INVENTION

A preferred embodiment of the invention will be described in detail below by referring to the accompanying drawings.

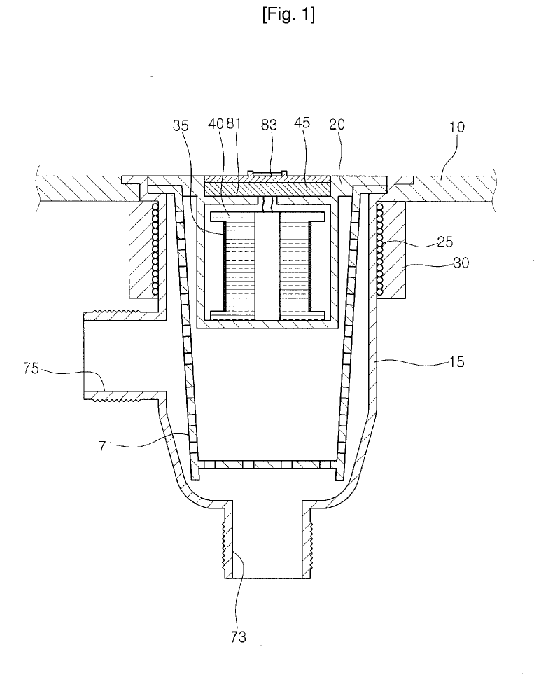

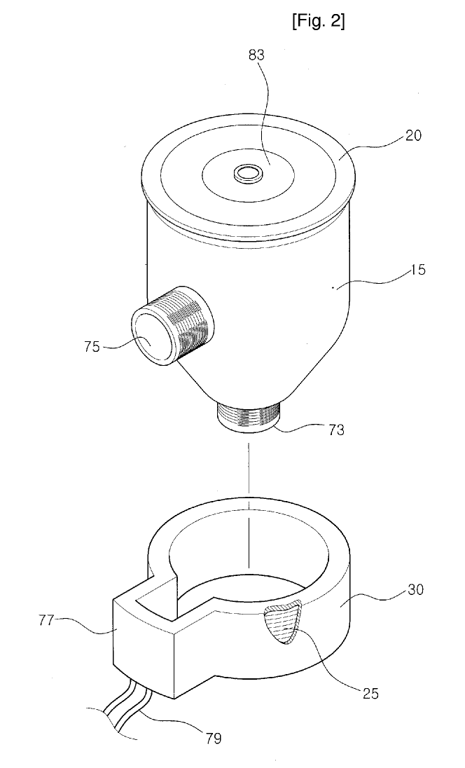

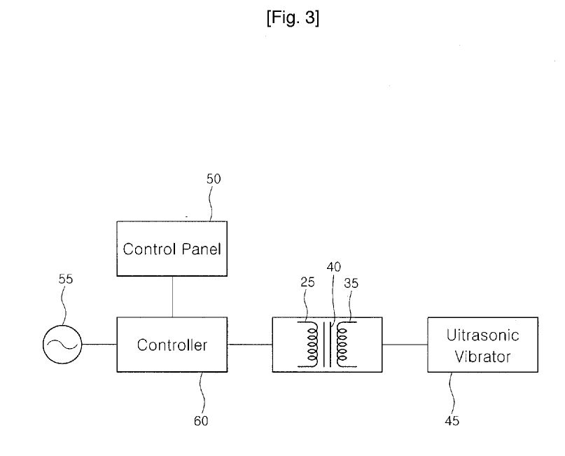

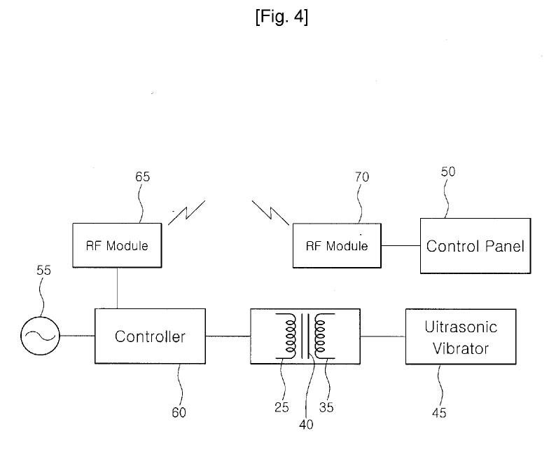

FIG. 1 is the cross-sectional view of a preferred embodiment of the invention, FIG. 2 is a dissembled perspective view of a outer body and a drain body of FIG. 1, FIG. 3 is a block diagram of the invention, FIG. 4 is the block diagram of another embodiment of the invention.

Referring to the drawings, the sink mounting type dish washer includes a outer body 30 which is detachably combined at the periphery of the drain body 12 and in which a first coil 25 is embedded, a core 40 which is sealingly embedded in the cap 20 and to the periphery of which a second coil 35 is winded, an ultrasonic vibrator 45 which is provided at the upper portion of the cap 20 and is connected to the second coil 35.

According to the invention, if electric current is supplied to the first coil 25, induction current is generated at the second coil 35 and the ultrasonic vibrator 45 is operated so that table dishes in the water container 10 may be washed.

Referring to FIG. 1, the sink will be described briefly. A drain body 15 which is connected to a drainage hole, a cap 20 which opens and closes the drain body 15, and a waste collection body 71 are provided at the bottom of the water container 10. A first drainage hole 73 to be connected to a U trap pipe is provided at the bottom of the drain body 15, and a second drainage hole 75 to be connected to an overflow pipe is provided at one side of the drain body 15. A outer body 30 having a first coil 25 therein is detachably mounted at the periphery of the drain body 15. The outer body 30 makes the first coil 25 detachably attached at the periphery of the drain body 15 and the outer body 30 insulates the first coil 25. FIG. 2 is a dissembled view of a outer body and a drain body 15 of FIG. 1. The outer body 30 is formed with ring shape for being inserted into the periphery of the drain body 15, and it has a projection portion 77 at its periphery corresponding to the second drainage hole 75. The outer body 30 may be easily combined at the periphery of the drain body 15 by detaching the U trap pipe and the overflow pipe and by inserting the outer body 35 from the lower side of the drain body 15 and by rotating the projection portion 77 in a predetermined angle. Here, an electric line 79 extending from the first coil 25 at one side of the outer body 35 is connected to a controller 60.

A core 40 is embedded in the cap 20, and a second coil 35 is winded to the periphery of the core 40. For providing the mounting space for the core 40, the cap 20 is downwardly extended in a predetermined length. And, for insulating the core 40, the inner space of the cap 20 is designed sealingly. The core 40 is made of Mg or Ni in order to have high magnetic permeability, and the second coil 35 is winded at the periphery of the core 40 so that induction current may be generated when a current is supplied to the first coil 25. The second coil 35 is connected to an ultrasonic vibrator 45 mounted at the upper side of the cap 20 and operates the ultrasonic vibrator 45. Referring to the embodiment of FIG. 1, a seating portion 81 whose central portion is grooved downwardly is formed at the upper side of the cap 20 so that the ultrasonic vibrator 45 may be seated on the seating portion 81. And, a protection cover 83 is combined on the upper surface of the ultrasonic vibrator 45. The protection cover 83 insulates the ultrasonic vibrator 45 from the washing water as well as transmits vibration to the washing water filled in the water container 10.

FIG. 3 and FIG. 4 are the block diagrams schematically showing the invention. Referring to the drawings, a controller 60 is provided in the sink. The controller 60 supplies electric power 55 to the first coil 30 according to the signal inputted from a separate control panel 50. Preferably, the controller 60 is embedded in the cabinet 85 below the water container 10 to be hidden, and the control panel 50, as shown in FIG. 4, is positioned in the place where a user may operate easily. An on/off switch 87, a washing time setting button 89, and LCD 91 may be provided on the control panel 50. LDC 91 may display the states of washing operation, reservation, current time and so on. The controller 60 transmits the current of high frequency. The controller 60 may be made of MICOM and various control circuits. And, the controller 60 may have various functions like as washing time setting, reservation. The controller 60 supplies electric power to the first coil 25, and the detailed circuit configuration of the controller 60 may be variously chosen by a manufacturer or a designer. Accordingly, the description of the detailed circuit configuration is omitted.

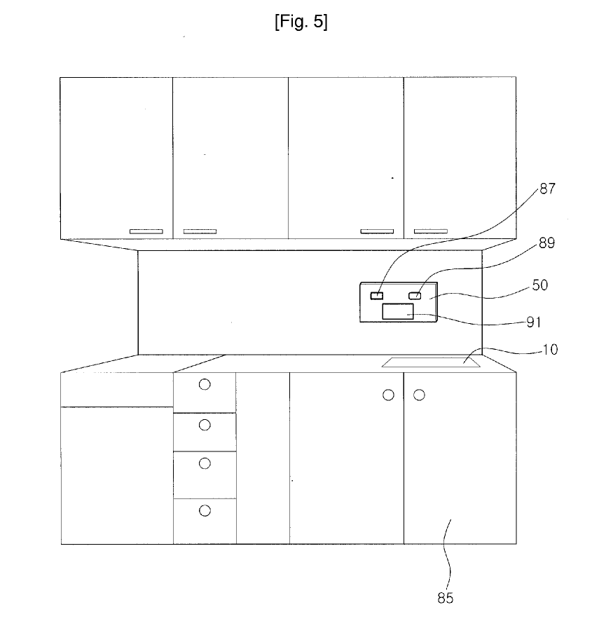

In a way, as shown in FIG. 4, RF modules 65, 70 are respectively provided to the controller 60 and the control panel 50, and the control signal may be transmitted wirelessly by the RF modules 65, 70. In this case, the control panel 50 may be freely mounted so that, as shown in FIG. 5, the control panel 50 may be positioned at the upper position of the water container 10 where the user may easily operate. And, electric line is not used from the control panel 50 to the inner portion of the sink so that the appearance may be improved. And, the control panel 50 may be provided not as a type which is mounted at special position but as a remote unit type which the users may carry it.

The sink mounting type dish washer of the invention may be attached to a conventional sink by a simple work that the user simply inserts the outer body 30 having a first coil 25 into the periphery of the drain body 15 and may replace the conventional cap with the cap 20 having a second coil 35 and an ultrasonic vibrator 45. Accordingly, the invention has the advantage that may save the cost and make the space of the kitchen more spacious because a user need not buy a new dish washer or need not replace the conventional sink. And, the invention has the advantage that waste of resource may be prevented because the conventional sink may be used.

Obviously, various modifications and variations of the invention are possible without departing from the principles of the invention. It is therefore to be understood that within the scope of the appended claim, the invention may be practiced otherwise than as specifically described herein.

### INDUSTRIAL APPLICABILITY

According to the above-described invention, the invention has the advantage that it may be easily attachable to a conventional sink and may save the cost because a consumer need not buy a new dish washer or need not replace the conventional sink with a new sink. And, the invention has the advantage that it may make the kitchen more spacious.

1. A sink mounting type dish washer comprising:
a drain body 15 mounted at the bottom of a water container 10;
a cap 20 which is provided at the upper portion of the drain body 12 and opens and closes the drain body 12;
an outer body 30 which is detachably combined at the periphery of the drain body 12 and in which a first coil 25 is embedded;
a core 40 which is sealingly embedded in the cap 20 and to the periphery of which a second coil 35 is winded;
an ultrasonic vibrator 45 which is provided at the upper portion of the cap 20 and is connected to the second coil 35 in the cap 20 and is operated by the induction current generated at the second coil 35;
and a controller 60 which is connected to the first coil 25 and supplies electric power to the first coil 25 by the signal inputted from a separate control panel 50;
and wherein washing function may be provided to the conventional sink because the outer body 30 having the first coil 25 may be inserted into the drain body 15 and the conventional cap may be replaced with the cap 20 having the core 40 to the periphery of which the second coil 35 is winded.

2. A sink mounting type dish washer of claim 1 further comprising:
RF modules 65, 70 which are respectively provided on the controller 60 and the control panel 20;
and wherein the control panel 20 may be arbitrarily located because a signal may be wirelessly transmitted from the control panel 20 to the controller 60.
